(19) United States
(12) Patent Application Publication
(10) Pub. No.: US 2012/0241654 A1
(43) Pub. Date: Sep. 27, 2012

(54) ERGONOMIC HAND KNOB HAVING ASYMMETRICAL FLUTES

(75) Inventor: Jason D. Clifford, Brooklyn Park, MN (US)

(73) Assignee: TESCOM CORPORATION, Elk River, MN (US)

(21) Appl. No.: 13/052,719

(22) Filed: Mar. 21, 2011

(51) Int. Cl. F16K 31/00; G05G 1/10

(52) U.S. Cl. 251/96; 74/553

(57) ABSTRACT

An ergonomic hand knob for a control valve includes a valve body and a plurality of flutes disposed in the valve body, each flute including a flute surface. Each flute is asymmetric with respect to an innermost point of the flute surface. A first flute surface has a greater slope than a second flute surface. The first flute surface lays in a direction of tightening from the innermost point and the second flute surface lays in a direction of loosening from the innermost point.

### FIELD OF THE INVENTION

The present invention relates generally to hand knobs. More specifically, the present invention relates to hand knobs having asymmetrical flutes.

### BACKGROUND

Hand knobs are used in a variety of applications to provide a gripping object or gripping surface. Some hand knobs are provided on items that need to be pulled, e.g., dresser drawers. These hand knobs are generally fixed with respect to the item. Typical hand knobs of this type include a larger body portion and a narrowed neck portion that is attached to the item. A user may grasp the larger body portion, placing a palm of the hand proximate the larger body portion, while the fingers wrap around a back of the larger body portion, the narrowed neck portion fitting between two fingers. The larger body portion in this case is generally circular or conical in shape with a smooth or textured exterior.

In other situations, a hand knob is rotated to operate a mechanism, such as a door latch, or a fluid valve. In the case of a door latch, the hand knob (or door knob) is shaped similar to the fixed hand knobs discussed above, but the door knob is rotatably connected to a door. When the door knob is rotated, a door latch operates to latch and unlatch a door. The rotation forces required to operate the door latch are substantially similar in each direction, whether. latching or unlatching the door. Often, the door knob may be biased to the latched position with a biasing member, such as a spring. Because the rotational forces are substantially similar in each direction and because the rotational forces are generally light, such door knobs are generally smooth and symmetrically shaped on an outer surface.

In the case of fluid control valves, operation of the valve may require greater rotational forces on the hand knob. As a result, valve hand knobs may include one or more symmetrical protrusions or recesses in an external surface to increase leverage and/or gripping effectiveness for the hand knob.

Known hand knobs for fluid control valves are based on the assumption that rotational forces in either direction will be substantially the same. As a result, known hand knobs for fluid control valves are generally symmetrical about a rotational axis. Moreover, any protrusions or recesses in the hand knob are also known to he symmetrical both with respect to a radius extending from the rotational axis to the outer perimeter of the hand knob, and with respect to other protrusions or recesses. While such hand knobs provide a more effective gripping surface than smooth surfaced hand knobs, known hand knobs are not generally as effective in a valve closing direction as a valve opening direction because closing the valve often requires mo rotational force to overcome fluid flowing through the valve, than opening the valve.

### SUMMARY

An ergonomic hand knob for a control valve includes a valve body and a plurality of flutes disposed on the valve body, each flute including a flute surface. The flute surface is asymmetric with respect to an innermost point of the flute surface. A first flute surface has a greater slope than a second flute surface. The first flute surface lays in a direction of tightening from the innermost point and the second flute surface lays in a direction of loosening from the innermost point.

### BRIEF DESCRIPTION OF THE DRAWINGS

FIG. 1 is a side elevational view of one embodiment of a hand knob constructed in accordance with the teachings of the disclosure.

FIG. 2 is a top plan view of the hand knob of FIG. 1.

FIG. 3 is a top plan view o part of the hand knob of FIG. 1.

FIG. 4 is a cross-sectional view of a fluid control valve including the hand knob of FIG. 1.

### DETAILED DESCRIPTION OF THE PREFERRED EMBODIMENTS

Although the following text sots forth a detailed description or an exemplary embodiment of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Based upon reading this disclosure, those of skill in the act may be able to implement one or more alternative embodiments, using either current technology or technology developed after the filing date of this patent. Such additional indictments would still fall within the scope of the claims defining the invention.

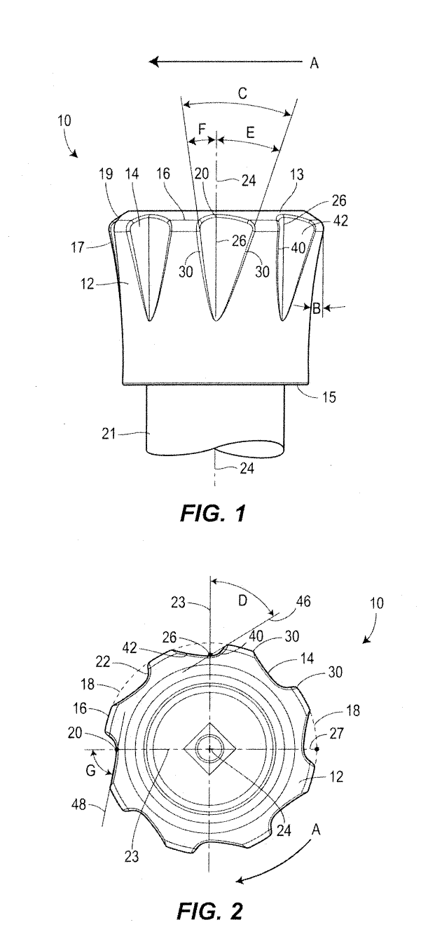

Referring now to the drawings, FIGS. 1 and 2 illustrate one embodiment of an ergonomic hand knob 10 constructed in accordance with the teachings of the disclosure. The hand knob 10 includes a substantially cylindrical knob body 12. In other embodiments, the knob body 12 may have other shapes, such as a square cylinder, an oval cylinder, a disk, etc. The knob body 12 may include a top surface 13, a bottom surface 15, and a side surface 17. The top surface 13 may be connected to the side surface 17 via a chamfered surface 19. In other embodiments, the chamfered surface 19 may be eliminated if desired. The knob body 12 may be attached to an actuator stem or other valve actuating device 21, and may be rotated in a tightening direction, as represented by arrow A, and a loosening direction, opposite of arrow A. The knob body 12 may taper slightly from top to bottom as illustrated in FIG. 1. The slight taper, defined by angle B, may be in the range of approximately −20 degrees to approximately 20 degrees, preferably in the range of approximately −10 degrees to approximately 10 degrees, and more preferably in the range of approximately 3 degrees to approximately 7 degrees.

The knob body 12 includes one or more flutes 14 that provide an improved gripping surface. The flutes 14 are defined by hollowed out or concave portions of the knob body 12. The flutes 14 are separated by one or more protrusions or teeth 16. Outer surfaces of he teeth 16 may define a generally circular perimeter 18 of the valve body 12. The flutes 14 include an innermost point 20 that is defined as an intersection between a flute surface 22 and a radius 23 drawn from an axis rotation 24 of the hand knob 10, wherein the distance between the flute surface 22 and the axis of rotation 24 is minimized about a circumference of the valve body 12. The innermost point 20 defines a line or trough 26 along the flute 14, as illustrated in FIG. 1. The innermost point 20 may also be defined as the maximum distance 27 between the flute surface 22 and the circular perimeter 18.

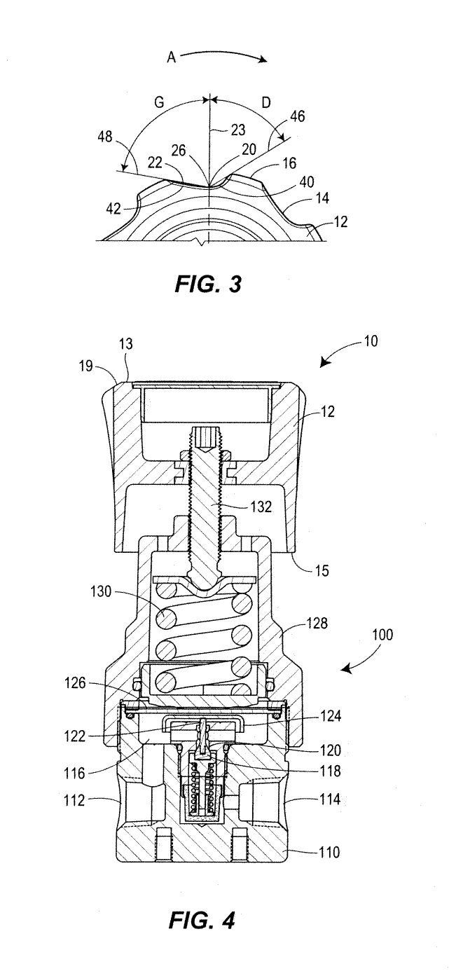

The flute surfaces 22 as illustrated in FIGS. 2 and 3, or when viewed in cross-section perpendicular to the axis of rotation 24, may be defined by the mathematical formula:

y=7E−05x⁴+0.002x³+0.0295x²+0.0389x−0.0289

wherein the origin lies at the innermost point 20 of the flute 14. Because the knob body 12 tapers inwardly from top to bottom (as viewed in FIG. 1), the flutes 14 become shallower nearer to the bottom surface 15 than near the top surface 13. The angle of taper B is defined as the angle between the side surface 17 and a line that is parallel to the axis of rotation 24 and tangent to the intersection of the chamfered surface 19 and the side surface 17. The line or trough 26 is also substantially parallel to the axis of rotation 24 in this embodiment. However, in other embodiments, the line or trough 26 may be oriented at an angle with respect to the axis of rotation 24; for example, the angle may be between approximately −45 degrees and approximately 45 degrees. Side edges 30 of the flute 14 converge near the bottom surface 15. The angle of convergence C between the side edges 30 may be in the range of approximately 5 degrees to approximately 55 degrees, preferably in the range of approximately 21 degrees to approximately 31 degrees, and more preferably in the range of approximately 25 degrees to approximately 27 degrees. Tops of the side edges 30 may be located below the top innermost point 20 due to the top surface 13 being located above a top of the side surface 17. While the side edges 30 converge with one another at the angle of convergence C, the side edges 30 may be inclined at different angles relative to the line or trough 26 (or the axis of rotation 24). For example, the angle of convergence C may be comprised of angles E and F, angle E being defined between the line or trough 26 id a first side edge 30 in the direction of loosening (i.e., opposite of arrow A in FIGS. 1 and 2), and angle F being defined between the line or trough 26 and a second side edge 30 in the direction of tightening (i.e., in the direction of arrow A). Angle E may be greater than angle F. In the embodiment illustrated in FIGS. 1-4, angle E may be approximately 18 degrees and angle F may be approximately 8 degrees. However, angles E and F ay be adjusted with respect to one another in virtually any combination as long as angle C (i.e., the sum of angles E and F) remains within the above described ranges.

Each flute 14 is asymmetric about the line or trough 26. Each flute 14 includes a first surface 40 and a second surface 42 separated by the line or trough 26. The first surface 40 lies in the tightening direction A from the radius 23 and the second surface 42 lies in the loosening direction from the radius 23. Each surface 40, 42 has a slope defined by a line drawn from the innermost point 20 or trough 26 to an intersection of the surface 40, 42 and the circular perimeter 18. A first slope 46 of the first surface 40 is steeper than a second slope 48 of the second surface 42. In other words, the first slope 46 is inclined more relative to the circular perimeter 18 than the second slope. An angle D between the first slope 46 and the radius 23 is in the range of approximately 48 degrees to approximately 68 degrees, preferably in the range of approximately 52 degrees to approximately 64 degrees, and more preferably in the range of approximately 56 degrees to approximately 60 degrees, and angle G between the second slope 48 and the radius 23 is in the range of approximately 70 degrees to approximately 90 degrees, preferably in the range of approximately 74 degrees to approximately 86 degrees, and more preferably in the range of approximately 78 degrees to approximately 82 degrees. The relationship between the first and second surfaces 40, 42 results in greater leverage and thus, the application of greater turning force, in the tightening direction A when the hand knob 10 is rotated.

In other embodiments, the hand knob 10 may be operatively engaged with a planetary gear system to provide increased or reduced torque, as required, when operating the hand knob 10. The hand knob 10 could be engaged with the planetary gear system to provide more torque when tightening the hand knob 10, and disengaged from the planetary gear system into direct drive contact when loosening the hand knob 10.

Turning now to FIG. 4, the hand knob 10 is connected to a fluid control valve 100. The fluid control valve 100 includes a valve body 110 having a fluid inlet 112 and a fluid outlet 114. A fluid passageway 116 connects the fluid inlet 112 with the fluid outlet 114. A valve plug 118 is disposed within the fluid passageway 116 and the valve plug 118 interacts with a valve seat 120 to control fluid flow through the valve 100. The valve plug 118 is connected to a valve stem 122, which is connected, in turn to a diaphragm plate 124. A diaphragm 126 is connected to the diaphragm plate 124 and the diaphragm 126 separates fluid flow within the valve 100 from an interior of a bonnet 128. Within the bonnet 128, a spring 130, or other biasing element, may bias the diaphragm 126, and thus the valve plug 118, towards an open or closed position. Spring force may be adjusted with an adjustment mechanism, such as a threaded rod 132 that is connected to the hand knob 10. As the hand knob 10 is turned, the threaded rod 132 adjusts the force of the spring 130 on the diaphragm 126 to control the rate of fluid flow through the valve 100. The hand knob 10 provides a user increased leverage, and thus increased turning power, when adjusting the valve 100.

Numerous modifications and alternative embodiments of the invention will be apparent to those skilled in the art in view of the forgoing description. Accordingly, this description is to be construed as illustrative only and is for the purpose of teaching those skilled in the art the best mode of carrying out the invention. The details of the present disclosure may be varied without departing from the spirit of the invention, and the exclusive use of all modifications which are within the scope of the claims is reserved.

1. A hand knob comprising:
a knob body having a top surface, a bottom surface, and a side surface; and
a plurality of flutes disposed in the side surface, each flute having a flute surface, he flute surface being asymmetric about a trough defined by an innermost point in the flute surface.

2. The hand knob of claim 1, wherein the flute surface includes a first surface and a second surface, the first surface laying in a direction of tightening, and the second surface laying in a direction of loosening of the hand knob.

3. The hand knob of claim 1, wherein the first surface defines a first slope and the second surface defines a second slope, the first slope being steeper than the second slope.

4. The hand knob of claim 3, wherein the first slope is in the range of approximately 48 degrees to approximately 68 degrees.

5. The hand knob of claim 4, wherein the first slope is in the range of approximately 52 degrees to approximately 64 degrees.

6. The hand knob of claim 4, wherein the first slope is in the range of approximately 56 degrees to approximately 60 degrees.

7. The hand knob of claim 3, wherein the second slope is in the range of approximately 70 degrees to approximately 90 degrees.

8. The hand knob of claim 7, wherein the second slope is in the range of approximately 74 to approximately 86

9. The hand knob of claim 8, wherein the second slope is in the range of approximately 78 degrees to approximately 82 degrees.

10. The hand knob of claim 7, wherein the first slope is in the range of approximately 48 to approximately 68.

11. The hand knob of claim 1, wherein at least one flute surface is defined by the mathematical formula: y=7E−05x⁴+0.002x³+0.0295x²+0.0389x−0.0289.

12. The hand knob of claim 1, wherein the knob body tapers from top to bottom.

13. The hand knob of claim 12, wherein an angle of taper of the knob body is in the range of approximately −20 degrees to approximately 20 degrees.

14. The hand knob of claim 1, wherein each flute includes two side edges that converge with one another from top to bottom.

15. The hand knob of claim 14, wherein an angle of convergence between the two side edges is in the range of approximately 5 degrees to approximately 55 degrees.

16. The hand knob of claim 14, wherein the angle of convergence is made up of two angles, a first angle between a trough, defined by an innermost point of the flute surface, and a first side edge, and a second angle between the trough and a second side edge, the first angle being greater than the second angle.

17. The hand knob of claim 16, wherein the first angle is approximately 18 degrees and the second angle is approximately 8 degrees.

18. The hand knob of claim 1, wherein the flutes are separated by teeth.

19. The hand knob of claim 1, wherein at least one flute becomes shallower from top to bottom.

20. A control valve including an ergonomic hand knob, the control valve including:
a valve body including a fluid inlet, a fluid outlet, and a fluid passage connecting the fluid inlet and the fluid outlet;
a valve plug disposed within the fluid passage, the valve plug interacting with a valve seat in the fluid passage to control fluid flow through the valve body;
a valve stern connected to the valve plug; and
a hand knob connected to the valve stem, which moves the valve plug relative to the valve seat, the hand knob including a knob body and a plurality of flutes disposed in the valve body,
wherein the plurality of flutes are asymmetric with respect to innermost points of the flute, the flute including a first flute surface and a second flute surface, the first flute surface having a first slope and the second flute surface having a second slope, the first slope being greater than the second slope.
